(19) United States
(12) Patent Application Publication
(10) Pub. No.: US 2002/0161905 A1
(43) Pub. Date: Oct. 31, 2002

(54) IP security and mobile networking

(75) Inventors: Henry Haverinen, Tampere (FI); Jukka-Pekka Honkanen, Tampere (FI); Antti J. Kuikka, Toijah (FI)

Correspondence Address: HARRINGTON & SMITH, LLP, 4 RESEARCH DRIVE, SHELTON, CT, 06484-6212, US

(73) Assignee: Nokia Corporation, Espoo (FI)

(21) Appl. No.: 10/119,509

(22) Filed: Apr. 9, 2002

(30) Foreign Application Priority Data
Apr. 26, 2001 (FI) 20010876

(51) Int. Cl. G06F 15/16; G06F 12/14; G06F 11/30; H04L 9/32

(52) U.S. Cl. 709/229; 713/200; 709/230

(57) ABSTRACT

The invention discloses a method transferring packets between a mobile host device (100) and a source node via a number of independent data networks while maintaining a secure connection. The independent networks may include, for example, the Internet (120), localized Access Zones (110, 140), a Corporate Intranets, a Home Network (130) etc. Problems may occur, for example, when the mobile node is using a co-located care-of address, in which case both IP-in-IP and IPsec tunneling transformations are performed, and the current IPsec and IP-in-IP implementations cannot perform the required tunneling operations on the mobile host. This is because the IP-in-IP and IPsec tunneling when the IP-in-IP tunnel is not the outermost transformation. In an embodiment of the invention, the security policy operated by the mobile host includes a primary security policy and a dynamic secondary security policy that selectively apply specified transformations to certain packets in the data transfer.

### FIELD OF THE INVENTION

The present invention relates generally to mobile network connections and, more specifically, to IP security and policies which govern those connections.

### BACKGROUND OF THE INVENTION

The benefit of using the Internet to obtain access to the wealth of information available online and that portion of the Internet comprising the World Wide Web (WWW) is widely recognized. Traditional ways of accessing the Internet have in the past been performed through stationary access points such as at work, school, or at home. The concept of stationary access points has been at the root of the Internet model from the beginning. By way of example, Internet Protocol (IP) routes packets to their destinations according to their IP addresses. The IP addresses are associated with a fixed physical location much the same way as conventional phone numbers are associated with the physical locations of fixed line phones. This association with the physical location allows IP packets to be routed to their intended destination in an efficient and effective way.

The traditional concept of connectivity has undergone changes caused by the trend toward mobility as witnessed, for example, by the transition to mobile telephony in recent years. Mobile computing is another area that is gaining popularity where benefits can be clearly achieved by allowing users the freedom of carrying out their work irrespective of their location. Furthermore, reliable access to the Internet will enable mobile networking to provide improved productivity for all users by freeing them from the ties that bind us to the office. More and more the trend is moving toward wireless connections that provide even more freedom by allowing access from virtually any location such as on airplanes and in automobiles, for example.

However, the Internet paradigm using fixed addresses poses some difficulties for seamless reliable use by mobile devices. This is because when a mobile device attaches to a new network or access point the IP address associated with the new network gives rise to a new IP address for the mobile device. Thus packets destined for its original IP address will not get delivered to the new IP address. One solution that has been proposed to overcome these problems is Mobile IP (RFC2002). Mobile IP is a standard proposed by the Internet Engineering Task Force to solve the problem of mobile access by allowing a mobile device to have two IP addresses: a home address and a care-of address that changes with each new point of access. The basic idea behind Mobile IP is that it allows the convenience of seamless roaming between networks where packets sent to the mobile device are able to find their way correctly regardless of the network the mobile device is attached to.

Typically packets from a source node find their way to the destination node by being routed from the incoming network interfaces to outbound interfaces using routing tables. The routing tables contain information on the next hop for each destination IP address. The packets are able to find their way to the mobile device by allowing a home address that is static which makes it appear that the mobile node is continually able to receive data on its home network. Thus a home agent network node is used to collect the packets destined for the mobile node and forwards them to the care-of address of the mobile node when it is attached to a foreign network. Since the care-of address changes with each new network attachment point, this information must be known by the home agent so it can redirect the packets. To accomplish this, the care-of address is registered with its home agent whenever the mobile node moves or acquires a new IP address.

The delivery of the packets to the mobile node requires that the packet be modified so that the care-of address is the destination IP address in a process known as packet transformation. The new header destined for the mobile node is formed by a transformation that encapsulates (also referred to as tunneling) the original packet so that the routing is not affected by the home network until it safely reaches the mobile node. At the destination, a reverse transformation is applied to the packet so that it appears to have the mobile node's home address as the destination address so the packet can be process properly by the transport protocol e.g. TCP (transmission control protocol). A foreign agent is typically used to de-encapsulate the packets received from the home agent for forwarding to the mobile node.

The foregoing describes a basic form of IP tunneling however Mobile IP typically supports three tunneling mechanisms: IP encapsulation within IP (RFC 2003), minimal encapsulation within IP (RFC 2004), and GRE (Generic Routing Encapsulation, RFC 1701). The implementation of multiple IP tunneling mechanisms is referred to as IP-in-IP tunneling. In addition to use with Mobile IP, these IP-in-IP tunneling mechanisms can be used for situations where it is desirable to connect networks that use private address spaces over the Internet, or to tunnel multicast traffic over a network which does not support tunneling, for example.

One of the primary concerns with Mobile IP is that of security. The open nature of the Internet inherently exposes transmitted packets to security issues which are compounded by the movement of mobile nodes between different sub-networks. To deal with these issues, an IP security protocol (or simply IPsec) specified in RFC2401 was developed to provide end-to-end security for the payload of packets when transmitting between IP hosts. This is chiefly accomplished by providing the hosts with datagram-level authentication and encryption of packets, typically by using symmetric cryptography that requires the use of the same keys at both ends. A key management protocol such as IKE can be used to generate the symmetric keys for use in a IPsec stack such as employed in a Virtual Private Network (VPN), for example.

An IPsec enabled host maintains a security policy in a Security Policy Database (SPD), as specified in RFC2401, for example. The SPD identifies which kind of security is applied for the traffic e.g. an IPsec policy may require that all traffic packets are tunneled with an Encapsulating Security Payload (ESP) to a VPN gateway with the exception of certain packets which are passed through without IP processing. The example of the security policy described here will be performed and effected on all packets passing through the host node. Since the security policy is typically static and configured into the host during the installation of the networking software, there exists access scenarios which pose particular difficulties when using the statically configured security policy. As an illustration, a mobile host that roams to a foreign network that has an IPsec security gateway between the visited network and the home agent and if the mobile node is using a co-located care-of address (in which case it needs to do both IP-in-IP and IPsec tunneling), the current IPsec and IP-in-IP implementations cannot perform the required tunneling operations on the mobile host. This is because the IP-in-IP and IPsec tunneling when the IP-in-IP tunnel is not the outermost transformation.

In current operating systems, IP-in-IP tunnels are typically configured as pseudo network interfaces. If IP-in-IP tunneling is required for traffic a routing table entry that routes the traffic to the pseudo tunneling interface is created. Since routing table is applied below the IPsec policy in the protocol stack, this implementation forces the IP-in-IP tunneling to be the outermost transformation for the packet. However, this is not always the desired operation. For example, if a mobile node that is operating with co-located care-of address wishes to AH-tunnel (Authentication Header tunnel) all traffic to its default gateway (the access router), the AH tunneling should be the outermost transformation and the IP-in-IP tunneling the second outermost transformation in order to successfully recover the packet.

In view of the foregoing, it is an objective of the invention to provide a technique that successfully addresses the disadvantages of the prior art with respect to IP security and the routing of packets to and from mobile nodes.

### SUMMARY OF THE INVENTION

Briefly described and in accordance with an embodiment and related features of the invention, in a method aspect there is provided a method of sending and receiving packets in a secure connection between a first network node and a second network node, wherein said packets may be transferred through a plurality of independent data networks in the path between the first network node and second network node, and that the first network node and each of the data networks and may operate under different security policies for specifying certain transformations that are applied to the packets, said method is characterised in that the first network node is able to dynamically change its security policy such that the suitable transformations are applied to the packets in order to maintain the secure connection.

In an apparatus aspect, there is provided a mobile device capable of establishing a connection with a network and having a data transfer security policy governing the transfer of packets to and from the mobile device, wherein the data transfer security policy comprises:

a first set of transformations associated with a primary security policy for application to the transferred packets; and

a second set of transformations associated with a secondary security policy for suitable application to the transferred packets.

### BRIEF DESCRIPTION OF THE DRAWINGS

The invention, together with further objectives and advantages thereof, may best be understood by reference to the following description taken in conjunction with the accompanying drawings in which:

FIG. 1 depicts an exemplary usage scenario unsuitable for use in the prior art;

FIG. 2 illustrates the prior art TCP/IP stack on an IPsec enabled host;

FIG. 3 illustrates an exemplary IP packet resulting from the usage scenario;

FIG. 4 depicts a protocol stack operating in accordance with an embodiment of the invention;

FIG. 5 illustrates the use of routing table entries in accordance with an alternative embodiment of the invention;

FIG. 6 illustrates an enhancement of the routing table embodiment of the FIG. 5;

FIG. 7a illustrates IPsec processing for outbound traffic operating in accordance with the embodiment of the invention;

FIG. 7b is a continuation of FIG. 7a for the outbound traffic operating in accordance with the embodiment; and

FIG. 8 illustrates the IPsec processing for inbound traffic operating in accordance with the embodiment of the invention.

### DETAILED DESCRIPTION OF THE INVENTION

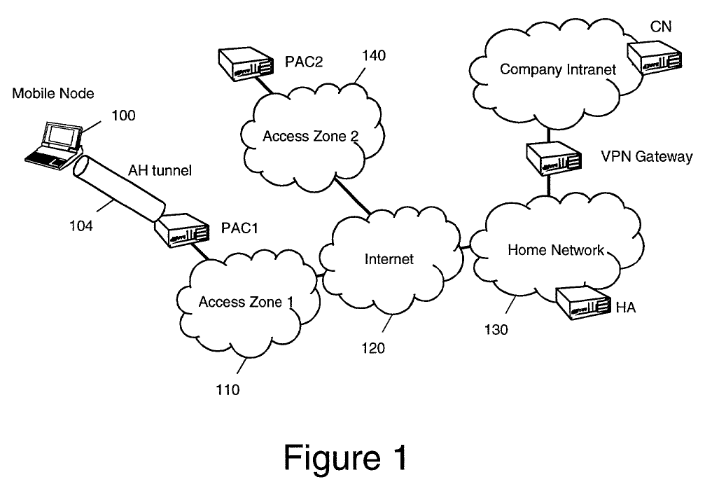

FIG. 1 depicts an exemplary usage scenario that cannot be accommodated by a traditional static IP security policy implementation. As an illustration, this can happen, for example, when a business user tries to establish a connection to his company's Intranet with a mobile terminal while away from the office. The connection may need to occur through several unrelated access zones and networks, each of which may operate under different security policies, thereby making the reverse packet transformations incompatible. As shown a mobile terminal 100 accesses the Internet 120 through Access Zone 1 110. As a result, an IPsec AH (Authentication Header) tunnel 104 is constructed between the terminal 100 and the nearest router PAC1 (public access controller 1). The primary purpose of the AH tunnel is to prevent unauthenticated users from using the terminal's IP address for sending packets to the Internet.

A mobile functionality can be enabled by using Mobile IP for handovers between access zones or handovers between, for example, a WLAN access zone and a GPRS wireless data network. Mobile IP typically uses an IP-in-IP tunnel between the terminal's current care-of address and its home agent (HA). When the terminal 100 wants to access corporate data provided by a correspondent node (CN), this would generally occur through a VPN gateway. The VPN gateway may be implemented with its own security policy e.g. an IPsec ESP (Encapsulating Security Payload) tunnel between the terminal home address 100 and the VPN gateway. As Mobile terminal 100 roams, a handover of the connection occurs in which an AH-tunnel is established with router PAC2 (public access controller 2) for accessing the company Intranet via Access Zone 2 140 to the CN. The IP packets that traverse between the Correspondent Node and the mobile node undergo several transformations, each dictated by the multiplicity of security policies in effect. As a result, both IP-in-IP and IPsec tunnels may be established whereby the IP-in-IP tunnel is not the outermost transformation which leads to difficulties in recovering the packets when using prior art implementations to attempt to decapsulate IP-in-IP tunnels of Mobile IP before the other IPsec decapsulations.

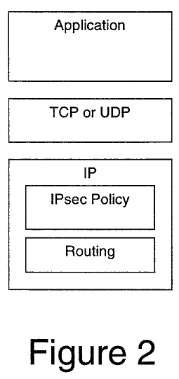

FIG. 2 illustrates the prior art TCP/IP stack on an IPsec-enabled host. The IP-in-IP tunneling is implemented as a pseudo network device. A routing table entry may direct outgoing traffic to an IP-in-IP tunnel device. For incoming traffic, the IP-in-IP tunneling is removed before giving the packet up to the IPsec policy. As shown, the IPsec transformations are done above the routing so that the IP-in-IP tunneling transformation is always the outermost transformation. In other words, the resulting IP-in-IP tunneling header is always the outermost IP header which becomes problematic when attempting packet recovery by performing the reverse transformations.

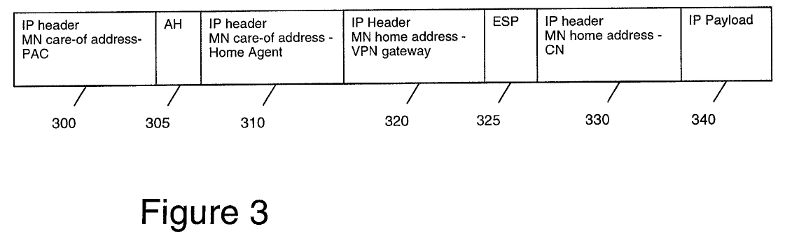

FIG. 3 illustrates what a resulting exemplary IP packet looks like at the mobile node after being subjected to a number of security policies from associated networks. The outermost transformation is the AH tunnel 104 of FIG. 1 comprising the IP header 300 between the terminal's current care-of address and the PAC. Inside the AH tunnel 305, there is an IP-in-IP tunnel of Mobile IP between the terminal's current care-of address and the home agent (HA) that comprises IP header 310. The AH may include processes such as check sum and authentication codes for ensuring packet security. Furthermore, inside the IP-in-IP tunnel there is the VPN tunnel between the terminal's home address and the VPN gateway that comprises IP header 320. Inside the VPN tunnel, there is the original IP packet comprising header 330 and payload 340 that is transmitted between the terminal's home network and the correspondent node. The security policy at the VPN gateway may specify an Encapsulating Security Payload (ESP) for all packets from the CN, as shown by reference numeral 325. It is therefore necessary that the AH tunneling should be the outermost transformation and the IP-in-IP tunneling the second outermost transformation. It can be clearly seen from the header structure that the IP-in-IP tunneling transformation is not the outermost transformation and therefore a prior art TCP/IP stack is not able to properly recover the packet.

In accordance with the invention, the aforementioned problem can be overcome by performing the IP-in-IP tunneling such that it is part of the IPsec processing. This is achieved by implementing a dynamic IPsec strategy that allows the application of various security policies to apply different processing to different kinds of traffic. In an embodiment of the invention, the IPsec implementation maintains two security policy databases (SPDs): a primary SPD for the VPN and a dynamic secondary SPD for Mobile IP.

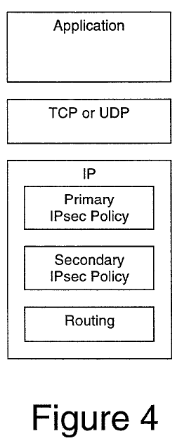

FIG. 4 depicts a protocol stack operating in accordance with an embodiment of the invention. The procedure of the embodiment is capable of inserting the IP-in-IP tunneling transformation between IPsec transformations since the IP-in-IP tunneling is implemented in the secondary IPsec policy and not as part of the IP routing. This allows the reverse transformations to occur in the proper order. In the preferred embodiment the primary policy is configured so that each primary SPD entry includes a flag that specifies whether the secondary policy should be applied to the packets. Since the secondary policy is below the primary policy in the protocol stack, this means that for outgoing traffic, the primary policy is applied before the secondary policy. On the other hand, for incoming traffic, the secondary policy is applied before the primary policy. The secondary policy can be configured dynamically by the mobility software on the mobile computer, which may specify that the traffic must be AH tunneled to the access router in the current access zone, for example. Operating above the primary and secondary security policies in the protocol stack are higher level transport protocols such as TCP or UDP (User Datagram Protocol) and the applications that run on top of them.

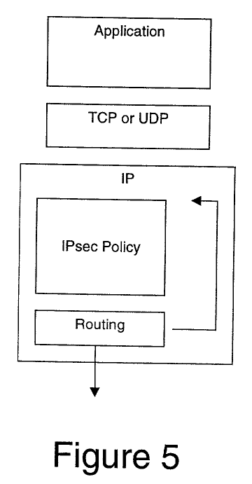

FIG. 5 illustrates an alternative embodiment of the invention. Here the routing table has been enhanced with entries that can forward the outgoing packet back to the IPsec processing. In this case, the first run in the IPsec policy applies all the static (primary) IPsec transformations such as the VPN transformation. For outbound traffic, the routing table may be dynamically configured by the mobility software. In the embodiment, the mobility software may set up IP-in-IP tunnels in the routing table. There can be entries in the table that require running the IPsec policy again. If IP-in-IP tunneling is applied to a packet, then different rules in the IPsec policy may match during the second run. The second run of the IPsec policy applies all the dynamic (secondary) transformations. For inbound traffic, reverse transformations are checked to conform to the local IPsec policy, whereby the check may take the local IP-in-IP tunneling configuration and routing table into account.

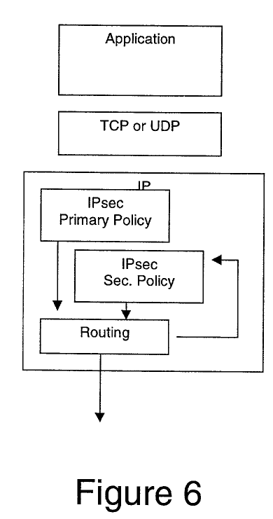

FIG. 6 illustrates a further enhancement of the routing table to the alternative embodiment of FIG. 5. In this embodiment, the security policy has been divided into two parts: a primary security policy for IPsec and a secondary policy for mobility software. An advantage of having a logically separate secondary policy is that run time changes do not compromise the primary policy. The secondary policy can be applied to the packet when the routing table indicates that it is required. This can be accomplished, for example, with an attribute such as a flag that is set in the routing table entry indicating such action is required.

In accordance with the invention, the operation of the protocol stack results in different procedures for handling outbound and inbound IP packets from the perspective of the source network and application.

Outbound Processing

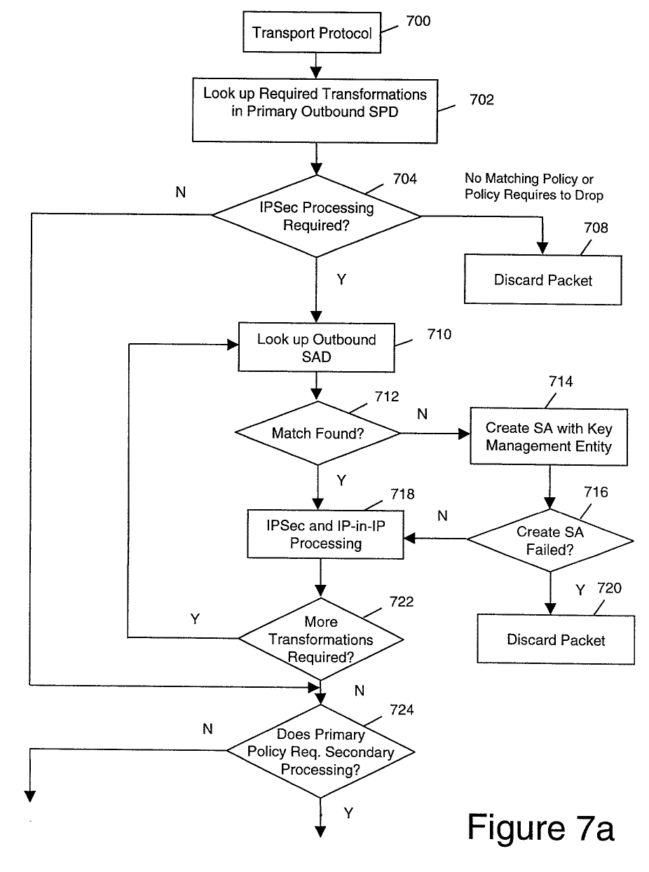

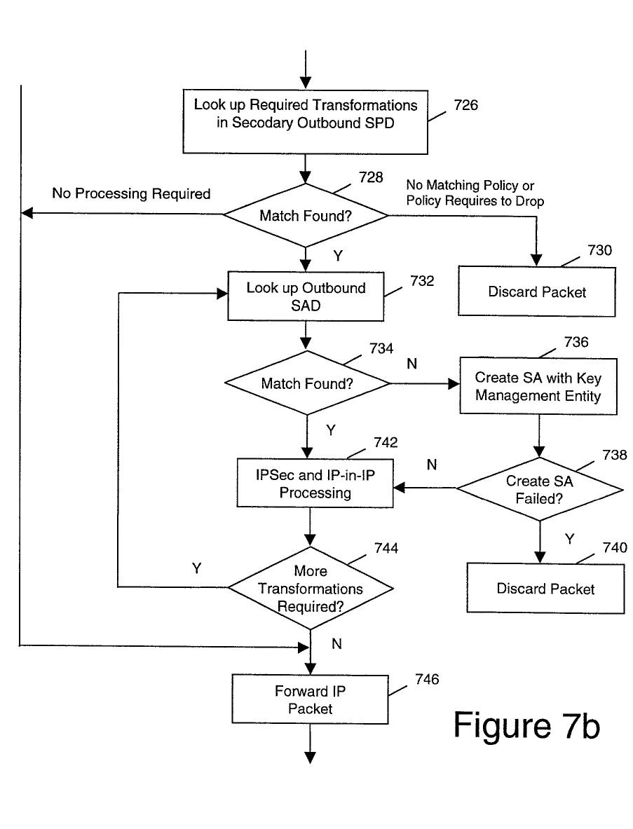

FIG. 7a illustrates IPsec processing for outbound traffic operating in accordance with the embodiment of the invention. An exemplary packet arrives from a source application via a transport protocol such as TCP, as shown in step 700. In step 702, an operation begins by looking up the required transformations in the primary outbound SPD. Once the lookup has occurred, a determination is made on whether the IPSec processing is then required, as shown in step 704. If no primary transformations are required the packet is checked to determine whether processing is required by the secondary policy in step 724. If no match is found, or if the policy requires that the packet be dropped then the packet is discarded at this point in step 708. When an SPD match that requires IPsec processing is found, a lookup is performed in the outbound Security Association Database (SAD) in step 710.

The Security Policy Database (SPD) contains policies that specify whether particular packets must be processed. The security associations in the Security Association Database (SAD) contain the parameters that are needed to perform the operations dictated by the policy. Examples of parameters include items such as encryption and authentication keys. The security associations are identified with an integer identifier called Security Parameter Index (SPI). This number is included in the IPsec headers (AH and ESP) and it is used to look up the SAD in inbound packet processing where, in outbound processing, a suitable SA is looked up based on the matching security policy. The security associations are typically created dynamically by a key management protocol such as the Internet Key Exchange (IKE), which is the standard key management protocol in IPsec. A security association is always required in order to apply an IPsec transformation. For IP-in-IP transformations there is no need for keys, SPIs or other parameters thus a SAD entry for these transformations are not required when they are implemented in the IPsec policy.

In step 712, a check is made to determine if there is a match in the SAD. When a match is found the IPsec performs the IPsec transformation as specified in the security policy using the parameters in the SA, as shown in step 718. When a match in the SAD is not found, a Security Association (SA) is created with a key management entity such as the IKE protocol, as shown in step 714. If the creation of the SA failed after the check in step 716, then the packet is discarded, as shown in step 720. The successful creation of the SA leads to the commencement of the transformation in step 718. Because security associations are not needed to perform IP-in-IP encapsulation transformations, the SAD lookup (step 710) is not necessarily required for SPD entries that specify IP-in-IP transformations. When such a policy is found in step 704, the operation can directly proceed to step 718 and perform the transformation. Alternatively, the implementation may use “dummy” security associations for IP-in-IP transformations so that the processing is similar for IPsec and IP-in-IP. Typically, the primary SPD only specifies actual IPsec transformations, not IP-in-IP transformations. In step 722, a check is made to determine whether more transformations are required, if so, the SAD lookup is repeated in 710. When all the primary transformations have been applied, it is checked for whether the primary policy requires processing by the secondary policy, as shown in step 724.

FIG. 7b is a continuation of FIG. 7a whereby the checked packet for secondary processing is forwarded in step 746 to the mobile node when no secondary processing is required. When secondary processing is required, the secondary SPD is consulted in step 726. When no match is found or the secondary policy requires to drop the packet, the packet is discarded in step 730. With a match, the process of looking up the outbound Security Association Database (SAD) is performed in step 732. Not shown explicitly however is the case where an entry in the secondary SPD matches but requires no processing. In this case the packet is forwarded in step 746. As in the primary SPD processing, no security association is required for IP-in-IP transformations and therefore these transformations can be performed without looking up the SAD. For IPsec transformations, a check is always made to determine whether a match was found in the outbound SAD in step 734. The transformation is performed in step 742. When a match in the outbound SAD is not found, a Security Association (SA) is created with a key management entity, as shown in step 736. If the creation of the SA failed after checking (step 738), the packet is discarded in step 740. The successful creation of the SA leads to the commencement of the IPsec transformation in step 742. In step 744, a check is made for more transformations by the secondary policy, if so the operation returns to step 732. When there are no more transformations the packet is transmitted to the network, as shown in step 746.

In the embodiment of the invention the implementation of the IPsec is permitted to perform IP-in-IP tunneling where in the prior art the IP-in-IP tunneling is not performed in the IPsec. The entries in the primary SPD have been augmented with a flag that indicates whether secondary IPsec processing is required for packets that match the primary SPD entry. When the flag is set, then the IPsec implementation proceeds with the secondary processing after all the IPsec transformations required by the primary SPD have been performed. If the flag is not set, then no secondary IPsec processing is performed. In this case the IPsec processing is similar to operation in the prior art processing. When secondary IPsec processing is required, then the IPsec implementation performs the IPsec transformations as required by the secondary SPD.

Inbound Processing

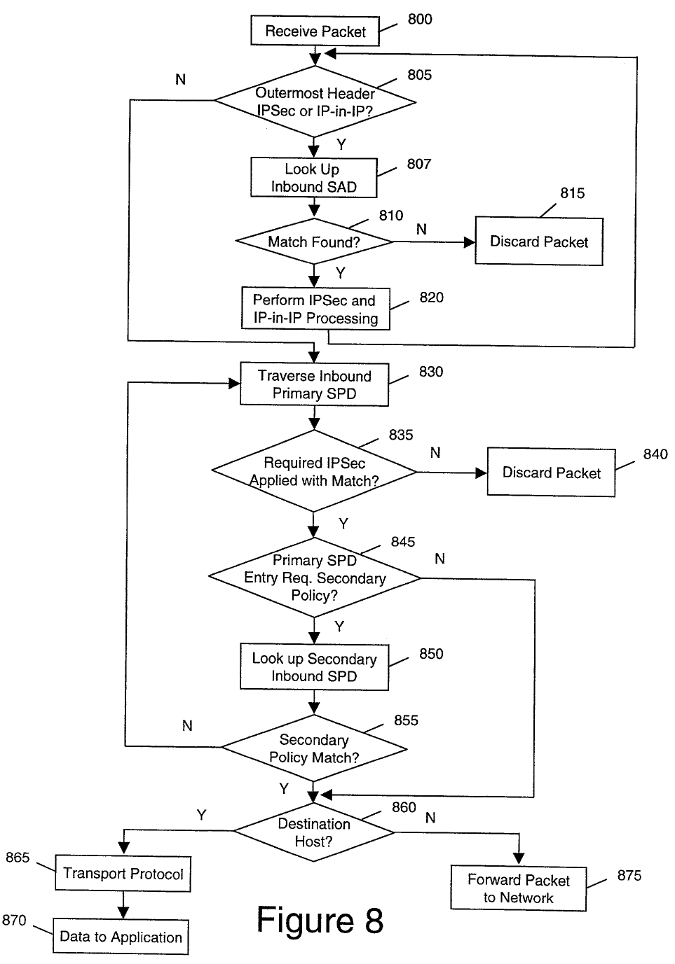

FIG. 8 illustrates the IPsec processing for inbound traffic operating in accordance with the invention. Step 800 shows a packet received from the network. In step 805, the outermost header is checked for an IP-in-IP or IPsec header. If the outermost header is not an IP-in-IP or an IPsec header, the processing continues in step 830. If the outermost header is an IP-in-IP or IPsec header, a security association is looked up in the SAD in step 807. A SAD look up is always required if the transformation is an IPsec transformation (AH or ESP). For IP-in-IP transformations, security associations are not necessarily required, although the implementation may use a “dummy” security association just to make the processing similar for IPsec and IP-in-IP transformations. In step 810, check is made to determine if there is a match. If a match is not found the packet is discarded, as shown in step 815. When there is a match, IPsec performs the transformation in step 820, whereby the security associations used (or IP-in-IP transformations performed without using security associations) and their order of application are kept track of. In step 805, a check is made for any remaining IPSec and/or IP-in-IP headers, if there are, the inbound SAD lookup of step 807 is repeated. If not, the primary inbound SPD is traversed in step 830 to determine whether the required transformations has been applied. This step is shown in step 835. If there was no matching policy then the packet is discarded, as shown in step 840. However, if the there is a match, a check is made in step 845 to determine whether the current primary SPD entry matches all or part of the applied processing. If the current primary SPD entry matches all of the applied processing and if it does not require secondary policy, then the packet is sent to the check for the destination host in step 860.

When the current primary inbound SPD entry matches all or part of the applied processing and requires secondary policy to be applied, a look up is performed on the secondary inbound SPD to determine if there is a secondary inbound SPD entry that matches the rest of the applied processing, as shown in step 850. If the primary policy entry already matches all of the applied processing, then there must be a secondary policy that requires no transformations. In step 855, a check is made to determine whether the rest of the applied processing matches a secondary SPD entry. If no matching secondary policy is found, the primary inbound SPD is again traversed back in step 830. The primary inbound SPD traversal is continued from the next unchecked policy.

The inbound processing operating in accordance with the embodiment of the invention performs the reverse IPsec and IP-in-IP transformations it encounters in the packet headers using the parameters in the SAD. Alternatively, an implementation may perform IP-in-IP transformations without requiring a matching SAD entry. According to the invention, IP-in-IP tunneling is an allowed transformation which is in contrast to the prior art. When all the IP-in-IP and IPsec headers have been processed, the IPsec implementations verifies that the packet matches the SPDs. The primary policy is traversed and entries are checked whether they match the processing that has been applied.

If an entry in the primary SPD matches the applied processing and the entry does not require secondary policy, then the IPsec implementation gives the packet to upper protocol layers or forwards it.

If, on the other hand, an entry in the primary SPD matches all the applied processing and the entry requires secondary policy, then the IPsec implementation checks whether there is a secondary policy that doesn't require any processing. If an entry in the primary SPD matches a part of the applied processing and the entry requires a secondary policy, the IPsec implementation then checks whether there is a secondary policy that matches the rest of the applied processing i.e. the portion not covered by the primary SPD entry. If a secondary SPD match is found, the IPsec implementation then gives the packet to the upper protocol layers or forwards it. If no matching secondary policy is found, the IPsec implementation continues traversing the primary SPD.

It should be noted that the Primary and secondary Security Policy Databases as described in the embodiment are conceptual data structures. Those skilled in the art will recognize that an actual implementation does not necessarily have to include two separate databases but may use a single database where entries include e.g. a SPD index field which indicates whether the entry belongs to the primary or secondary SPD. This type of implementation can be generalized to support more than two SPDs, given that the index has values other than 1 and 2, for example. Furthermore, the IPsec implementation could recursively apply SPD entries with ascending index.

Although the invention has been described in some respects with reference to a specified embodiment thereof, variations and modifications will become apparent to those skilled in the art. It is therefore the intention that the following claims not be given a restrictive interpretation but should be viewed to encompass variations and modifications that are derived from the inventive subject matter disclosed.

1. A method of sending and receiving packets in a secure connection between a first network node and a second network node, wherein said packets may be transferred through a plurality of independent data networks in the path between the first network node and second network node, and that the first network node and each of the data networks may operate under different security policies for specifying certain transformations that are applied to the packets, said method is wherein the first network node is able to dynamically change its security policy such that the suitable transformations are applied to the packets in order to maintain the secure connection.

2. A method according to claim 1, wherein the first network node is a mobile network node and the second network node is a source node, wherein the mobile network node includes a Security Policy Database (SPD) that comprises a plurality of security policies that can be dynamically applied to the packets in the connection.

3. A method according to claim 1, wherein first network node's security policy comprises a primary SPD and a secondary SPD, wherein the primary SPD includes entries for transformations of a primary security policy and the secondary SPD includes entries for transformations of a secondary security policy

4. A method according to claim 1, wherein the entries in the primary SPD are augmented with an attribute that indicates that the secondary security policy must be applied, may be applied, or must not be applied to the packets.

5. A method according to claim 1, wherein the primary SPD includes entries for “inner” transformations (inner headers) and the secondary SPD includes entries for “outer” transformations, and for outbound packets, inner transformations are performed before outer transformations and for inbound traffic and vice versa.

6. A method according to claim 1, wherein the secondary policy specifies additional transformations after all primary policy transformations have been applied for outbound traffic.

7. A method wherein inbound traffic is processed in a reverse order to that specified in claim 6.

8. A method according to claim 1, wherein the primary and secondary policies may be configured independently and simultaneously, wherein modification of the policies can be restricted to one or the other or both.

9. A method according to claim 1, wherein the primary security policy remains unchanged and the secondary security policy is configured to be selectively applied to certain packets.

10. A method according to claim 1, wherein the operations of the transformations include modifications to the packet such as adding and removing protocol headers or options, encapsulating and decapsulating packets within new packets, encrypting and decrypting the packet or part of the packet or compressing and decompressing the packet or part of the packet.

11. A method according to claim 10 wherein the operations of the transformations include the transport mode transformations using the Authentication Header (AH) and the Encapsulating Security Payload (ESP), and the encapsulation and decapsulations of IP-in-IP tunnels, Authentication Header (AH) tunnels, and Encapsulating Security Payload (ESP) tunnels.

12. A method according claim 2 wherein the mobile network node establishes a network connection using, for example, Mobile IP via connection with a locally defined Access Zone which supports roaming by handing over the connection to another Access Zone.

13. A method according to claim 1, wherein the independent networks include the Internet, local Intranets, Home Networks, localized Access Zones, and telecommunication networks such as wireless and non-wireless networks.

14. A method according to claim 1 wherein the security policies of the networks (or nodes) apply particular transformations to the packets as the packets are transmitted through the networks (or nodes), and wherein the suitable transformations applied to the packets are based on the particular transformations applied such that the particular transformations are effectively reversed in order to recover the packet payload data.

15. A mobile device capable of establishing a connection with a network and having a data transfer security policy governing the transfer of packets to and from the mobile device, wherein the data transfer security policy comprises:
a first set of transformations associated with a primary security policy for application to the transferred packets; and
a second set of transformations associated with a secondary security policy for suitable for selective application to certain packets.

16. A mobile device according to claim 15 wherein the primary security policy is a security policy that specifies processing for certain packets and the secondary security policy is a security policy that specifies processing for certain other packets.

17. A mobile device according to claim 15 wherein the transformation entries in the primary security policy includes a attribute such as, but not limited to, a flag bit for indicating whether the secondary security policy should be applied, not applied, or may not be applied to the packets.

18. A mobile device according to claim 15 wherein the mobile device connection to the Internet transfers packets over a transport layer such as TCP or UDP.
